(19) United States
(12) Patent Application Publication
(10) Pub. No.: US 2004/0034779 A1
(43) Pub. Date: Feb. 19, 2004

(54) Method and apparatus to authenticate digitally recorded information

(75) Inventors: Thomas Paine Wood, Signal Mountain, TN (US); Chadwick James Cox, Chattanooga, TN (US); Zachariah Morgan Gibson, Chattanooga, TN (US); Stephen Ralph Hayton, Kettering, OH (US); Robert Michael Pap, Chattanooga, TN (US)

Correspondence Address: Janet C. Donovan, 7001 Shallowford Road, Chattanooga, TN, 37421, US

(73) Assignee: Accurate Automation Corporation of Chattanooga, Te, Chattanooga, TN

(21) Appl. No.: 10/458,305

(22) Filed: Jun. 11, 2003

Related U.S. Application Data
(60) Provisional application No. 60/387,923, filed on Jun. 13, 2002.

(51) Int. Cl. H04L 9/00

(52) U.S. Cl. 713/176; 705/56; 380/277

(57) ABSTRACT

A method and apparatus to verify the authenticity of the recording is provided. An authentication code is calculated based on the contents of the recording and information describing the context of the recording. The authentication code provides assurance to a user of the recording that no elements of the recording have been altered. Recordings that are made for legal evidence purposes may include, but are not limited to audio and visual (image) information including motion pictures. Context information includes, but is not limited to date, time, longitude, latitude, camera or recorder serial number, camera orientation, camera optical parameters, and information about the recorder operator. When using such recordings for legal evidence, the authenticity of the recorded information is crucial, and also the authenticity of the parameters surrounding the recording is crucial. The method and apparatus contained herein permits unrestricted use of the recorded information, and provides a test of authenticity of the entire recording. Additionally, the serial number of the recorder is authenticated.

### CITED REFERENCES

### U.S. Patent Documents

U.S. Pat. No. 6,269,446 July 2001 Schumacher, et al.

U.S. Pat. No. 6,185,316 February 2001 Buffam

U.S. Pat. No. 5,987,136 November 1999 Schipper, et al.

U.S. Pat. No. 5,499,294 March 1996 Friedman

### BACKGROUND OF THE INVENTION

Digital recorders such as image (video) and sound recorders have become very widely used because of the ease of transporting a recording between users. It is practical to transport a digital recording across a local area network or across the internet. Additionally, it is practical to present a digital recording to multiple users simultaneously. Unfortunately, it has become very easy to alter digital recordings with inexpensive computers and software tools.

When a digital recording is offered as evidence that an incident occurred, one must question the authenticity of the recording. One technique to detect alterations of a digital image is a digital “watermark.” This embeds a digital authentication code directly into the recorded picture, presumably in a manner that does not affect the perceived quality of the picture. However, a digital “watermark” is an alteration, and in some situations any alteration is perceived negatively.

Some recording situations exist solely for the purpose of providing evidence, such as surveillance situations. In these situations, it is desirable to authenticate not only the recorded picture and the recorded sound, but it is additionally desirable to authenticate other recorded information such as time, place, recorder settings, recorder serial number, camera parameters, perhaps the operator of the recorder, and other parameters. Without authentication it is possible to falsify a recording by altering the related parameters while leaving the picture or sound original. A picture or sound recorded at one point in time, but altered to represent a recording at a different point in time may cause the user of that recording to reach an incorrect conclusion.

It is common practice to consolidate recorded information and recording parameters in a digital “file” or “record.” Many industry standards exist for such consolidated information such as JPEG (Joint Photographic Experts Group) and TIFF (Tagged Image File Format) in the picture industry, as well as MPEG (Motion Pictures Expert Group) in the audio/visual multimedia industry. Standard file formats must include information to completely rebuild the recording. Such information includes, at a minimum, the number of bits per pixel, whether a picture is monochrome or color, the number of horizontal pixels and the number of vertical pixels, the compression style (if any), scan directions (left to right, top to bottom), and other image parameters. Sound recordings must include sample rates, bits per sample, and compression styles (if any.) Many industry standards include provision for many digital parameters to be consolidated with the digitized pictures and sound. Collectively, all of the information recorded in a file or record is used to represent the recording and its attributes.

Information can be included in a file or record that represents a recording to indicate the conditions of the recording. This supplementary information can include date, time of day, location, camera or recorder number, operator, and other relevant information. A digital file or record may include a recording or recordings and information about the conditions of the recording. This file or record may be transported from the memory or disk of the recording computer to the memory or disk of other computers in the process of routine processing. Eventually, when the file or record of the recording is presented to an observer, it is desirable to include a means to verify that the observed recording and associated parameters are the same as the recording and parameters at the moment of recording. This verification of authenticity must be applied to the entire recording and associated information for the observer to fully trust that the digital file or record which is observed is identical to the recording and associated information at the moment of the original recording.

The unique function offered by this invention is the ability to authenticate both a recording and the conditions under which the recording was made. This authentication is later used when the recording is reviewed to confirm that what is reviewed is unaltered from the original recording. Means have existed to authenticate a picture, which would permit detection of any alteration of the picture from the original recording. But, those authentication means would permit an alteration or misrepresentation of the conditions of the recording to go undetected. A picture that was actually recorded at one instant of time could be represented as having been recorded at a different instant of time. Sometimes, recording conditions such as time of day are superimposed on the picture. This is undesirable because the characters representing the time may interfere with objects of interest within the picture. Additionally, it would be impractical to superimpose several conditions of recording including, but not limited to, date, time of day, longitude, latitude, recorder number, camera parameters, operator name, and other information onto the picture without significant loss of information content of the picture.

### SUMMARY OF THE INVENTION

The invention claimed herein is an apparatus and process to authenticate a digital recording and the conditions under which the recording was made. The authentication process claimed in this invention adds an authentication record to a digital recording in a way that does not affect the recording and does not affect the review of the recording. The authentication process claimed in this invention can be exercised when the recording is reviewed to determine if the recording and its related conditions are unchanged from the original recording.

For the purpose of this invention, the following definitions shall apply:

Digital Recording—any information pertaining to a scene that is recorded with a digital sensor onto digital media. A digital recording may include, but is not limited to, recordings of sound, pictures, temperature, location, and time.

Authentication—the ability of a person reviewing a digital recording to determine with confidence: a) the context in which the recording was made, and b) that the recording they are reviewing is unchanged from the original recording.

Conditions of Recording—the conditions at the instant the digital recording is produced. Conditions may include, but are not limited to, date, time of day, longitude, latitude, temperature, the serial number of the recorder, sensor parameters, and information about the person operating the recorder.

Original Digital Recording—a digital recording together with the conditions of recording that is unchanged from the instant the recording was made.

Tightly Coupled Authentication—a situation where the authentication encode process is an integral element of the digital recording process. This includes embedding the authentication encode devices directly into the digital recorder.

Loosely Coupled Authentication—a situation where the authentication encode process is not an integral element of the digital recording process, but rather is performed significantly later than the recording process by a different computing mechanism. This is the case where it is not practical to integrate authentication encode into the recording mechanism.

The authentication process claimed herein consists of an encoding process and a decoding process. In the authentication encoding process, an authentication record is computed at the instant the recording is made, and the authentication record is appended to the original digital recording. The authentication record has no effect on the process of reviewing the digital recording. Any device which is capable of reviewing a digital recording that does not contain an authentication record can also review the same digital recording containing an authentication record. The authentication record is a passive attachment. The authentication encoder may be a hardware device which is integrated with the digital recorder or the authentication encoder may be a software process that is executed within the processor that prepares the sensed information for recording. Each authentication encoder has a unique digital serial number which is contained within the authentication encoder device or processor. The authentication encoder must be carefully prevented from unauthorized copying to prevent fraudulent authentication encoding. If an unauthorized authentication encoder was made, it would be possible to produce a digital recording that had been properly authentication encoded, remove the authentication record, modify the digital recording and/or conditions of recording, and to re-perform the authentication encoding process. Such a modified digital recording would appear authentic.

The authentication decoding process analyses the digital recording, the conditions of recording, and the authentication record to determine if the digital recording and the conditions of recording have been modified from the original.

A digital signature of the original recording data is computed. The digital signature is a set of data containing fewer bytes than the original recording data, but mathematically representing the data content of the entire original recording. The digital signature may be as simple as a checksum, or a more complicated process containing many bytes. In a simple 8-bit checksum, all of the bytes of the original recording are summed (using 8-bit addition) while ignoring the carry resulting from the addition. The 8-bit value representing the sum of all bytes in the original recording is inverted (two's complement) and this 8-bit value is the checksum. This provides a condition where the process of summing all bytes of the original recording and then adding the sum to the checksum will provide an overall sum of 0 if the original data is unaltered. If any bits of the original data are altered, this summing process will produce a non-zero sum, thus indicating data corruption. However, an 8-bit checksum does not provide strong capability to detect corruption. If many bits of the original recording are randomly altered, the probability of a valid 8-bit checksum for random alterations is 1 in 256, or about 0.4%. An authentication process would not be very strong if it failed to detect corruption in 0.4% of the cases. To strengthen the authentication process, many more than 8-bits will be used in the digital signature data. In addition, the serial number of the authentication encoder will be appended to the digital signature so that an authentication decoder can determine which authentication encoder created the authentication block which it is attempting to verify.

The digital signature algorithm may be disclosed publicly, or it may be kept as a trade secret by the provider of the authentication process.

When the digital signature has been computed, it is encrypted. The encryption process is as follows: The digital signature ‘clear text’ message. The encryption process translates the ‘clear text’ message into an encrypted message, a ‘cipher text’ message. A decryption process translates the ‘cipher text’ message back to the identical ‘clear text’ message. This encryption process can be performed with an encryption/decryption process that is secret, or it can be performed with a disclosed algorithm that uses either public keys or symmetric keys. This encryption process prevents the generation of fraudulent authentication blocks.

### BRIEF DESCRIPTION OF THE DRAWINGS

FIG. 1 depicts the data flow through the authentication encode process. The original digital recording 1 is combined with the context 2 of the recording to compute a digital signature. The context data 2 may include time, recorder number, information about the operator, or other parameters. The digital recordings may be prepared from sounds, pictures, temperature, location, or other sensors. The digital signature of the original recording is computed 3 using the encryption key 5. A process 4 is performed to encrypt the digital signature. The original data recording 1, the encrypted signature, and the context data 2 is then combined into an authenticated recording 7 with a process 6. The authenticated recording may be saved to digital recording media (memory or disk) and it may be transmitted by local area network, internet, wired telecommunications, or wireless telecommunications to other processors or digital media. The authenticated recording may be replayed by standard digital displays or players as if there were no authentication block.

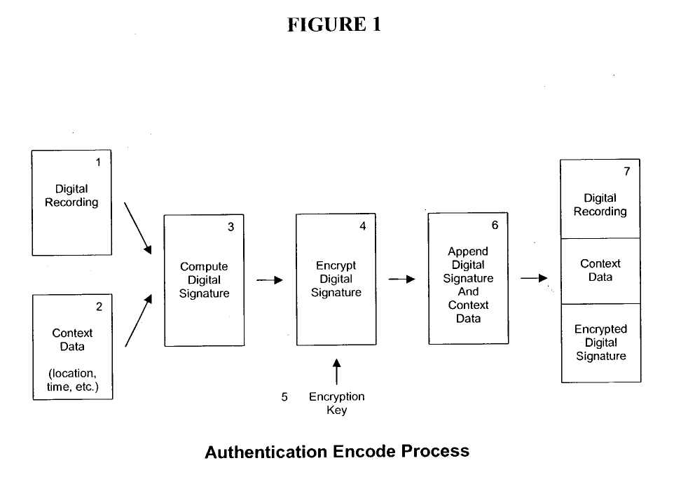

FIG. 2 depicts the data flow through the authentication decode and verify process. The authenticated recording under test 8 represents the concatenation of the original recording 1, the context data 2, and the encrypted digital signature. The authentication block is separated in process 9 producing the digital recording 10, the context data 11, and the encrypted digital signature 12. A process 13 is performed to compute the digital signature of the recording under test without the encrypted digital signature 12 producing the computed digital signature. A process 14 is performed to decrypt the digital signature of the recording under test. The computed digital signature from process 13 is compared to the decrypted digital signature from process 14. If these are identical, then the recording under test 8 is authentic. If these are not identical, then the recording under test is not authentic.

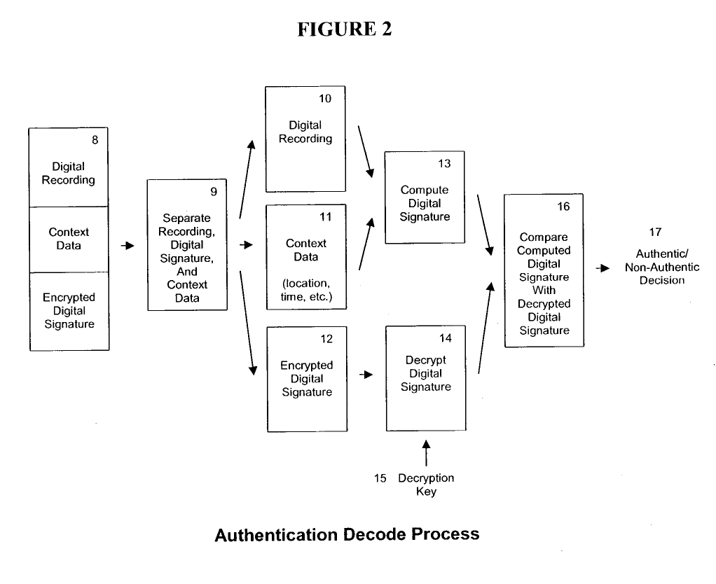

### DESCRIPTION OF THE PREFERRED EMBODIMENT

The invention consists of an authentication encoder or an authentication decoder or both an encoder and a decoder. The authentication encoder is implemented in conjunction with a recorder. The authentication encoder may be either tightly coupled or loosely coupled with the digital recorder. If the authentication encoder is integrated with the recorder and the authentication encode process occurs at the same moment as the recording, then the authentication encoder is tightly coupled with the digital recorder. However, if the authentication encoder is separate from the digital recording and the authentication encode process occurs significantly later after the digital recording takes place, then the authentication encoder is loosely coupled with the digital recorder. The authentication encoder may be implemented as a software process running on a general-purpose CPU, as a software process running on a special-purpose CPU (such as a Digital Signal Processor—DSP), or in hardware devices integrated with the recorder hardware.

The authentication decoder is operated in conjunction with devices that would permit review of the digital recording. In most cases, the digital recording will be reviewed on a general-purpose computer running review software. The authentication decoder will most often be implemented as software running on a general-purpose computer.

We claim:

1) A method and apparatus to authenticate a digital recording comprising:
a) a means to create the digital recording,
b) a means to process the digitally recorded elements of the scene to prepare for digital recording,
c) a means to digitally store the recorded information in digital memory media,
d) a means to supplement the digitally recorded information with parameters indicating the conditions under which the recording was made (including, but not limited to, date, time of day, location, camera or recorder number, operator name, etc.),
e) a means to compute a digital signature of the combination of the recorded information and the associated information,
f) a means to encrypt or hide the digital signature in a similar quantity of data that cannot be produced without knowledge of the digital signature process and knowledge of the hiding process,
g) a means to restore the original digital signature from the encrypted digital signature,
h) and a means to compare the calculated digital signature with the digital signature that was stored, and to declare the file or record authentic if the digital signature is unchanged from the original recording, and to declare the file or record non-authentic if the digital signature is altered from the original recording.

2) The method and apparatus of claim 1 wherein:
a) the visual sensor, if present, is a camera generating a signal corresponding to the visual content of the scene,
b) the audible sensor, if present, is a microphone generating a signal corresponding to the audio content of the scene
c) the location sensor, if present, may be a GPS (Global Positioning System) device determining longitude and latitude
d) the temperature sensor, if present, is a thermal sensor generating a signal corresponding to the temperature of the scene,
e) other electronic environmental sensors may be present to include those measurements in the recording.

3) The method and apparatus of claim 1 wherein the digital signature process may be:
a) a checksum process,
b) or any arithmetic process based on all of the recorded data and all of the parameters associated with the recorded data,
c) or any arithmetic process based on a defined subset of the recorded data and a defined subset of the parameters associated with the recorded data.

4) The method and apparatus of claim 1 wherein the encryption process is:
a) a public key encryption process,
b) or a symmetric key encryption process,
c) or any secret encryption process.

5) The method and apparatus of claim 1 wherein the authentication encode process is:
a) integrated closely with the recording mechanism (tightly coupled),
b) or performed much later by a different computing mechanism (loosely coupled).
